(19) United States
(12) Patent Application Publication
(10) Pub. No.: US 2026/0155416 A1
(43) Pub. Date: Jun. 4, 2026

(54) FUEL CELL

(71) Applicant: TOYOTA JIDOSHA KABUSHIKI KAISHA, Toyota-shi Aichi-ken (JP)

(72) Inventors: Kazunori SHIBATA, Mishima-shi Shizuoka-ken (JP); Kotaro IKEDA, Susono-shi Shizuoka-ken (JP); Kohei IKEDA, Anjo-shi Aichi-ken (JP)

(73) Assignee: TOYOTA JIDOSHA KABUSHIKI KAISHA, Toyota-shi Aichi-ken (JP)

(21) Appl. No.: 19/398,579

(22) Filed: Nov. 24, 2025

(30) Foreign Application Priority Data
Nov. 29, 2024 (JP) 2024-208396

(51) Int. Cl. H01M 8/1004; H01M 8/026

(52) U.S. Cl. CPC H01M 8/1004; H01M 8/026

(57) ABSTRACT

A fuel cell comprises a membrane electrode assembly, gas diffusion layers in a pair provided in such a manner that the membrane electrode assembly is interposed therebetween, and separators in a pair provided in such a manner that the gas diffusion layers in a pair are interposed therebetween. At least one of the separators in a pair has on a surface facing the gas diffusion layer a flow path part causing a reaction gas to flow therein, and a rib part provided next to the flow path part and in contact with the gas diffusion layer. The flow path part has a bottom surface spaced apart from the gas diffusion layer, and a side portion connecting the bottom surface and the rib part to each other. The side portion is provided with a groove extending from a connection between the side portion and the rib part toward the bottom surface.

### CROSS REFERENCE TO RELATED APPLICATIONS

The present application claims priority from Japanese patent application 2024-208396 filed on Nov. 29, 2024, the disclosure of which is hereby incorporated in its entirety by reference into the present application.

### BACKGROUND

### Field

The present disclosure relates to a fuel cell.

### Related Art

Various techniques have been suggested in relation to the configuration of a fuel cell. As an example, Japanese Patent Application Publication No. 2007-194041 discloses a separator having a concave-convex part for causing a reaction gas to flow therein. In this separator, a convex part forming the concave-convex part is curved in a thickness direction, thereby improving the performance of discharging generated water accumulated between the convex part and a gas diffusion layer.

Accumulation of the generated water in the fuel cell hinders flow of the reaction gas, causing a risk of reducing power generation performance. The water discharge performance is required to be improved further.

### SUMMARY

The present disclosure is feasible in the following aspects.

According to one aspect of the present disclosure, a fuel cell is provided. The fuel cell comprises a membrane electrode assembly, gas diffusion layers in a pair provided in such a manner that the membrane electrode assembly is interposed therebetween, and separators in a pair provided in such a manner that the gas diffusion layers in a pair are interposed therebetween. At least one of the separators in a pair comprises on a surface facing the gas diffusion layer a flow path part causing a reaction gas to flow therein, and a rib part provided next to the flow path part and in contact with the gas diffusion layer. The flow path part has a bottom surface spaced apart from the gas diffusion layer, and a side portion connecting the bottom surface and the rib part to each other. The side portion is provided with a groove extending from a connection between the side portion and the rib part toward the bottom surface.

### BRIEF DESCRIPTION OF THE DRAWINGS

FIG. 1 is a perspective view of a fuel cell device where a fuel cell according to one embodiment of the present disclosure is used;

FIG. 2 is a plan view of a separator;

FIG. 3 is a sectional view of the fuel cell cut at a position corresponding to a line III-III in FIG. 2;

FIG. 4 is a perspective view of a separator used in a fuel cell according to a second embodiment;

FIG. 5 is a perspective view of a separator used in a fuel cell according to a third embodiment; and

FIG. 6 is a perspective view of a separator used in a fuel cell according to a fourth embodiment.

### DETAILED DESCRIPTION

### A. First Embodiment

### <Configuration of Fuel Cell Device 100>

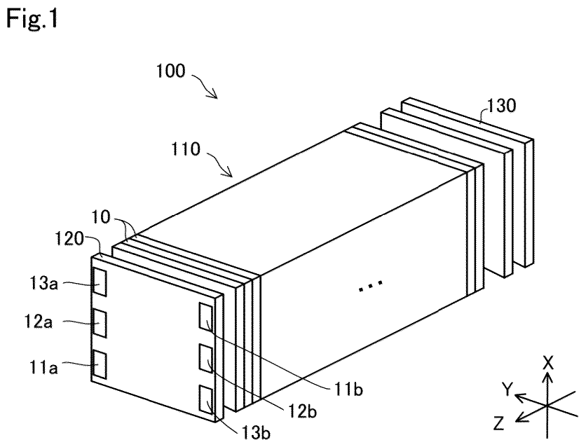

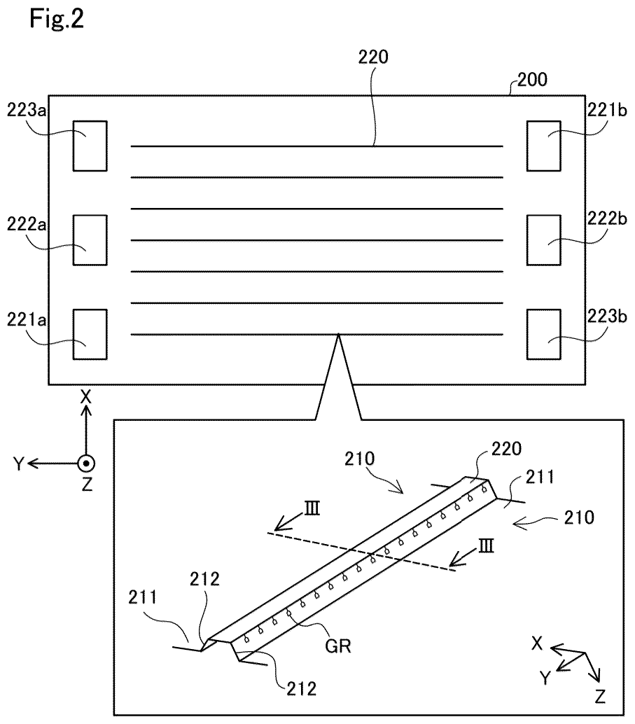

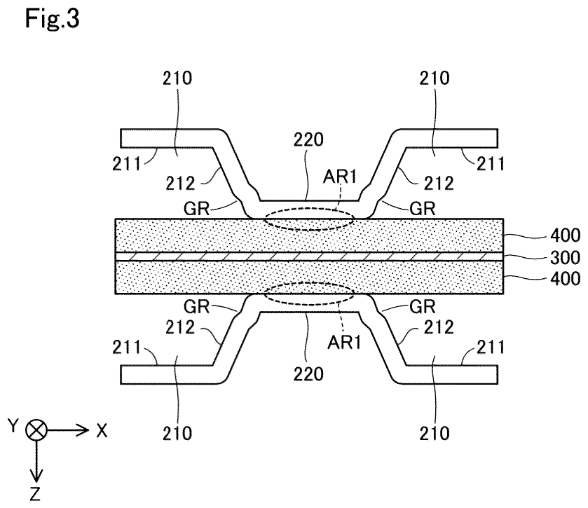

FIG. 1 is a perspective view of a fuel cell device 100 where a fuel cell 10 according to one embodiment of the present disclosure is used. FIG. 1 shows an X axis, a Y axis, and a Z axis orthogonal to each other. FIG. 2 is a plan view of a separator 200. A flow path part 210 and a rib part 220 described later are schematically shown in an enlarged manner in a lower section of FIG. 2. FIG. 3 is a sectional view of the fuel cell 10 cut at a position corresponding to a line III-III in FIG. 2. The fuel cell device 100 is used as a power source for an electric vehicle, for example. As shown in FIG. 1, the fuel cell device 100 includes a cell stack 110, and terminal plates 120 and 130 in a pair.

The cell stack 110 is composed of a plurality of the fuel cells 10 stacked in the Z direction. The fuel cell 10 is a solid polymer fuel cell that generates power using a reaction gas. The reaction gas includes oxygen as an oxidizing gas, and hydrogen as a fuel gas, for example. The fuel cell 10 has a rectangular appearance shape. The configuration of the fuel cell 10 will be described later in detail.

The terminal plates 120 and 130 in a pair are arranged at both ends of the cell stack 110 in a stacking direction. Each of the terminal plates 120 and 130 is composed of a conductive material such as aluminum or copper. Each of the terminal plates 120 and 130 is used for extracting power generated by the fuel cells 10 to the outside.

The fuel cells 10 are each provided with oxidizing gas manifolds 11a and 11b, cooling medium manifolds 12a and 12b, and fuel gas manifolds 13a and 13b. Each of these manifolds is composed of manifold holes formed at each of the terminal plates 120 and 130 and at the separator 200 described later. The oxidizing gas manifold 11a is used for supplying the oxidizing gas to the fuel cells 10. The oxidizing gas manifold 11b is used for discharging the oxidizing gas from the fuel cells 10. The cooling medium manifold 12a is used for supplying a cooling medium to the fuel cells 10. The cooling medium manifold 12b is used for discharging the cooling medium from the fuel cells 10. The fuel gas manifold 13a is used for supplying the fuel gas to the fuel cells 10. The fuel gas manifold 13b is used for discharging the fuel gas from the fuel cells 10.

### <Configuration of Fuel Cell 10>

As shown in FIG. 3, the fuel cell 10 includes a membrane electrode assembly 300, gas diffusion layers 400 in a pair provided in such a manner that the membrane electrode assembly 300 is interposed therebetween, and the separators 200 in a pair provided in such a manner that the gas diffusion layers 400 in a pair are interposed therebetween.

The membrane electrode assembly 300 is composed of an electrolyte membrane, an anode catalyst layer joined to one surface of the electrolyte membrane, and a cathode catalyst layer joined to the other surface of the electrolyte membrane. The electrolyte membrane is a solid polymer membrane having a proton-conducting property. The electrolyte membrane is an ion-exchange membrane composed of a fluorine resin, for example. The anode catalyst layer contains a catalyst that accelerates chemical reaction of the fuel gas, and carbon particles supporting the catalyst. The cathode catalyst layer contains a catalyst that accelerates chemical reaction of the oxidizing gas, and carbon particles supporting the catalyst.

The gas diffusion layers 400 uniformly diffuse the reaction gas flowing in the flow path part 210 described later to the membrane electrode assembly 300. The gas diffusion layers 400 are each composed of a porous body. The porous body is prepared using metal or a carbon material, for example. The gas diffusion layers 400 are provided parallel to the membrane electrode assembly 300.

The separator 200 suppresses leakage of the reaction gas from the fuel cell 10. The separator 200 is composed of a metallic material such as aluminum or titanium, for example. As shown in FIG. 2, the separator 200 has a rectangular appearance shape. The separator 200 is provided with six manifold holes 221a, 221b, 222a, 222b, 223a, and 223b. The manifold hole 221a is a part of the oxidizing gas manifold 11a. The manifold hole 221b is a part of the oxidizing gas manifold 11b. The manifold hole 222a is a part of the cooling medium manifold 12a. The manifold hole 222b is a part of the cooling medium manifold 12b. The manifold hole 223a is a part of the fuel gas manifold 13a. The manifold hole 223b is a part of the fuel gas manifold 13b.

As shown in FIG. 3, the separators 200 each has a plurality of the flow path parts 210 and the rib part 220 on a surface facing the gas diffusion layer 400. The rib part 220 is formed in such a manner as to be interposed between the corresponding flow path parts 210. Each of the flow path parts 210 causes the reaction gas to flow therein. More specifically, as shown in FIG. 2, the reaction gas is supplied through the manifold hole 221a or the manifold hole 223a into each of the flow path parts 210, and is discharged from each of the flow path parts 210 through the manifold hole 221b or the manifold hole 223b. The reaction gas flowing in each of the flow path parts 210 is supplied at least partially into the gas diffusion layer 400.

As shown in FIG. 3, each of the flow path parts 210 has a bottom surface 211, and side portions 212 in a pair. The bottom surface 211 is spaced apart from the gas diffusion layer 400. The bottom surface 211 is provided parallel to the gas diffusion layer 400. The side portions 212 in a pair each connect the bottom surface 211 and the rib part 220 described later to each other. The side portions 212 in a pair are connected to corresponding both ends of the bottom surface 211 in a width direction (X direction). Both the side portions 212 in a pair tilt in such a manner as to increase the width of the flow path part 210 from a side adjacent to the bottom surface 211 toward the gas diffusion layer 400. Thus, the flow path part 210 has a U-shape in a section parallel to the width direction. The configuration of the side portions 212 will be described later in detail.

The rib part 220 is provided between the corresponding flow path parts 210. The rib part 220 may also be said to be a part next to the flow path part 210. The rib part 220 has a flat surface. The rib part 220 is provided parallel to the gas diffusion layer 400 and in contact with the gas diffusion layer 400. Thus, a load applied in a thickness direction of the separator 200 acts on the gas diffusion layer 400 via the rib part 220. Both ends of the rib part 220 in the width direction connect to the respective side portions 212 belonging to two of the flow path parts 210 provided in such a manner as to interpose this rib part 220 therebetween.

The flow path parts 210 and the rib parts 220 described above are provided repeatedly, thereby providing the separator 200 with a concave-convex shape in a section orthogonal to a direction in which the reaction gas flows shown in FIG. 3. It can also be said that the separator 200 has an uneven shape in the section orthogonal to the direction in which the reaction gas flows shown in FIG. 3.

### <Detailed Configurations of Side Portion 212 and Groove GR>

As shown in the lower section of FIG. 2, in the present disclosure, the side portion 212 is provided with a plurality of grooves GR. Specifically, each of the grooves GR extends from a connection between the side portion 212 and the rib part 220 toward the bottom surface 211. The direction of the groove GR aligns with the longitudinal direction of groove GR. Each of the grooves GR is aligned in a lengthwise direction (Y direction) of the flow path part 210. In the present embodiment, a width of a portion of the grooves GR that is closer to the rib part 220 among the rib part 220 and the bottom surface 211 is narrower than a width of a portion of the grooves GR that is closer to the bottom surface 211 among the rib part 220 and the bottom surface 211. Each of the grooves GR may also be said to be a groove having a convex shape in a plan view that increases in width from a side adjacent to the rib part 220 toward the bottom surface 211. The smallest width of the groove GR is from 1 to 2 mm, for example. The largest width of the groove GR is from 5 to 8 mm, for example. The depth of the groove GR is from 1 to 5 mm, for example. The length of the groove GR is from 3 to 10 mm, for example.

Each of the grooves GR is used for water discharge from the gas diffusion layer 400 to the flow path part 210. In the fuel cell 10, water is generated on a cathode side as a result of reaction of the oxidizing gas. The water generated on the cathode side may move to an anode side across the membrane electrode assembly 300. Accumulation of the generated water hinders flow of the reaction gas to reduce power generation efficiency. For this reason, in embodiments, the generated water is discharged to the outside of the fuel cell 10 through the flow path part 210. In some cases, however, the generated water is accumulated in a contact area AR1 between the rib part 220 and the gas diffusion layer 400 shown in FIG. 3. The generated water accumulated in the contact area AR1 hinders move of the reaction gas between the flow path parts 210 or move of the reaction gas in the gas diffusion layer 400. This makes it difficult for the reaction gas to spread over the membrane electrode assembly 300 entirely. In response to this, by the provision of the grooves GR extending from the connection between the side portion 212 and the rib part 220 like in the present disclosure, it becomes possible to discharge the generated water accumulated between the rib part 220 and the gas diffusion layer 400 to the flow path part 210. The generated water discharged to the flow path part 210 is guided by the flow of the reaction gas to the outside of the fuel cell 10.

In the fuel cell 10 of the first embodiment described above, the side portion 212 is provided with the plurality of grooves GR extending from the connection between the side portion 212 and the rib part 220 toward the bottom surface 211. This allows generated water to be discharged from the contact area AR1 between the rib portion 220 and the gas diffusion layer 400 through each of the grooves GR. As a result, it is possible to improve water discharge performance.

In the fuel cell 10 of the first embodiment, a width of a portion of the grooves GR that is closer to the rib part 220 among the rib part 220 and the bottom surface 211 is narrower than a width of a portion of the grooves GR that is closer to the bottom surface 211 among the rib part 220 and the bottom surface 211. This allows generated water accumulated between the rib part 220 and the gas diffusion layer 400 to be guided to each of the grooves GR by capillary force. Thus, even if the reaction gas supplied to the fuel cell 10 flows at a low rate, for example, it is still possible to improve water discharge performance using capillary force.

### B. Second Embodiment

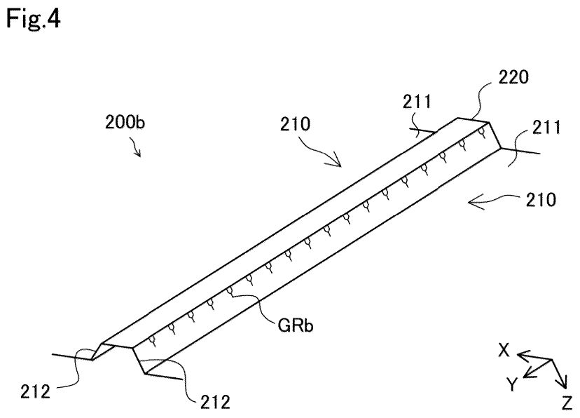

FIG. 4 is a perspective view of a separator 200b used in a fuel cell according to a second embodiment. FIG. 4 shows a part of the separator 200b viewed at a corresponding position to the enlarged view in the lower section of FIG. 2. In the separator 200b of the second embodiment, the shape of grooves GRb differs from that of the grooves GR in the separator 200 of the first embodiment. Description of the other configurations of the fuel cell of the second embodiment will be omitted as these configurations are the same as those of the fuel cell 10 of the first embodiment.

As shown in FIG. 4, a width of a portion of the grooves GR that is closer to the rib part 220 among the rib part 220 and the bottom surface 211 is wider than a width of a portion of the grooves GR that is closer to the bottom surface 211 among the rib part 220 and the bottom surface 211. The groove GRb may also be said to be a groove having a convex shape in a plan view that decreases in width from a side adjacent to the rib part 220 toward the bottom surface 211. The smallest width of the groove GRb is from 1 to 2 mm, for example. The largest width of the groove GRb is from 5 to 8 mm, for example.

In the fuel cell 10 of the second embodiment described above, a width of a portion of the grooves GR that is closer to the rib part 220 among the rib part 220 and the bottom surface 211 is wider than a width of a portion of the grooves GR that is closer to the bottom surface 211 among the rib part 220 and the bottom surface 211. This allows generated water accumulated between the rib part 220 and the gas diffusion layer 400 to be guided to the part of the groove GRb having the comparatively large width. Thus, even if the separator 200 is composed of a material having a comparatively low hydrophilic property and resultant capillary force is comparatively small, it is still possible to improve water discharge performance.

### C. Third Embodiment

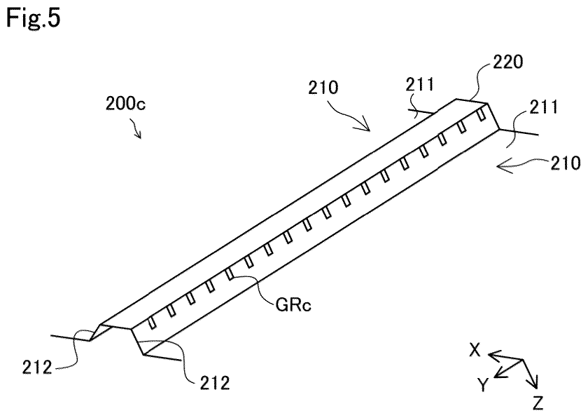

FIG. 5 is a perspective view of a separator 200c used in a fuel cell according to a third embodiment. FIG. 5 shows a part of the separator 200c viewed at a corresponding position to the enlarged view in the lower section of FIG. 2. In the separator 200c of the third embodiment, the shape of grooves GRc differs from that of the grooves GR in the separator 200 of the first embodiment. Description of the other configurations of the fuel cell of the third embodiment will be omitted as these configurations are the same as those of the fuel cell 10 of the first embodiment.

As shown in FIG. 5, the width of each of the grooves GRc is constant from a side adjacent to the rib part 220 toward the bottom surface 211. In other words, the groove GRc has a constant width along the longitudinal direction of the groove GRc. The groove GRc may also be said to be a groove having a linear shape in a plan view. The width of the groove GRc is from 1 to 5 mm, for example.

In the fuel cell of the third embodiment described above, the width of the groove GRc is constant from a side adjacent to the rib part 220 toward the bottom surface 211. This allows the groove GRc to be provided easily, compared to a configuration where a groove has a width differing between sites.

### D. Fourth Embodiment

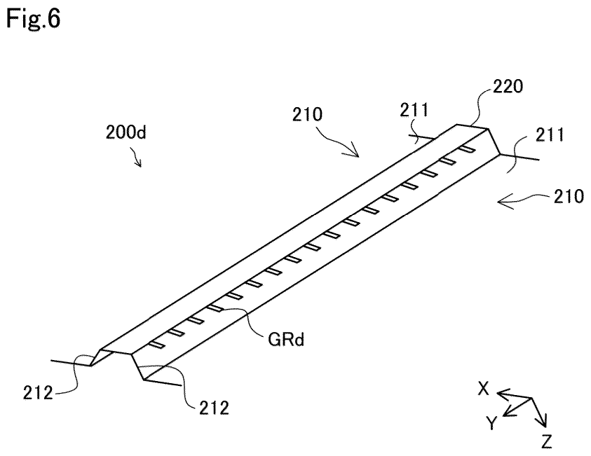

FIG. 6 is a perspective view of a separator 200d used in a fuel cell according to a fourth embodiment. FIG. 6 shows a part of the separator 200d viewed at a corresponding position to the enlarged view in the lower section of FIG. 2. In the separator 200d of the fourth embodiment, the shape of grooves GRd differs from that of the grooves GRc in the separator 200c of the third embodiment. Description of the other configurations of the fuel cell of the fourth embodiment will be omitted as these configurations are the same as those of the fuel cell of the third embodiment.

As shown in FIG. 6, each of the grooves GRd tilts in a direction in which the reaction gas flows. It may be said that the tilting direction of the groove GRd has a component in the direction in which the reaction gas flows. In the present embodiment, the reaction gas flows toward the-Y direction.

The configuration of the groove GRd of the fourth embodiment may be used in combination with the groove GR of the first embodiment or the groove GRb of the second embodiment. Specifically, a groove having an arbitrary shape may tilt in the direction in which the reaction gas flows.

In the fuel cell of the fourth embodiment described above, the groove GRd tilts in the direction in which the reaction gas flows. This allows generated water in the groove GRd to be easily discharged by the flow of the reaction gas to the outside of the fuel cell. Thus, it is possible to improve water discharge performance of the fuel cell.

### E. Other Embodiments

(E1) In the above-described first embodiment, the groove GR has a convex shape in a plan view that increases in width from a side adjacent to the rib part 220 toward the bottom surface 211. However, the present disclosure is not limited to this. The groove GR may have an arbitrary shape that increases in width from a side adjacent to the rib part 220 toward the bottom surface 211. In the above-described second embodiment, the groove GRb has a convex shape in a plan view that decreases in width from a side adjacent to the rib part 220 toward the bottom surface 211. However, the present disclosure is not limited to this. The groove GRb may have an arbitrary shape that decreases in width from a side adjacent to the rib part 220 toward the bottom surface 211.

(E2) In the above-described embodiments, the respective numbers of the grooves GR, GRb, GRc, and GRd are two or more. However, the present disclosure is not limited to this. The respective numbers of the grooves GR, GRb, GRc, and GRd may be only one.

(E3) In the above-described embodiments, the separators 200, 200b, 200c, and 200d are used in the fuel cells 10. However, the present disclosure is not limited to this. The separators 200, 200b, 200c, and 200d may be used in water electrolysis cells.

(E4) In the above-described embodiments, the grooves GR, GRb, GRc, and GRd may be provided at only one of the separators 200 in a pair, one of the separators 200b in a pair, one of the separators 200c in a pair, and one of the separators 200d in a pair.

(E5) In each of the above-described embodiments, the flow path part 210 may be formed as a so-called serpentine flow path extending back and forth in a meandering pattern in a region between the manifold holes 221a and 223a on the supply side of the reaction gas and the manifold holes 221b and 223b on the discharge side of the reaction gas.

(E6) In each of the above-described embodiments, the rib part 220 has a flat surface. However, the present disclosure is not limited to this. The rib part 220 may have a curved surface.

The present disclosure is not limited to the embodiments described above and is able to be realized with various configurations without departing from the spirit thereof. For example, the technical features in the embodiments are able to be replaced with each other or combined together, as appropriate, in order to solve part or the whole of the problems described previously or to achieve part or the whole of the effects described previously. When the technical features are not described as required features in the present specification, they are able to be deleted, as appropriate. The present disclosure may be realized in the following aspects, for example.

(1) According to one aspect of the present disclosure, a fuel cell is provided. The fuel cell comprises a membrane electrode assembly, gas diffusion layers in a pair provided in such a manner that the membrane electrode assembly is interposed therebetween, and separators in a pair provided in such a manner that the gas diffusion layers in a pair are interposed therebetween. At least one of the separators in a pair comprises on a surface facing the gas diffusion layer a flow path part causing a reaction gas to flow therein, and a rib part provided next to the flow path part and in contact with the gas diffusion layer. The flow path part has a bottom surface spaced apart from the gas diffusion layer, and a side portion connecting the bottom surface and the rib part to each other. The side portion is provided with a groove extending from a connection between the side portion and the rib part toward the bottom surface.

In the fuel cell of this aspect, the side portion is provided with the groove extending from the connection between the side portion and the rib part toward the bottom surface. This allows generated water to be discharged from the gas diffusion layer through the groove. As a result, it is possible to improve water discharge performance.

(2) In the fuel cell of the above aspect, a part of the groove closer to the rib part may be smaller in width than a part of the groove closer to the bottom surface.

In the fuel cell of the above aspect, a width of a portion of the groove that is closer to the rib part among the rib part and the bottom surface is narrower than a width of a portion of the groove that is closer to the bottom surface among the rib part and the bottom surface. This allows generated water accumulated between the rib part and the gas diffusion layer to be guided to the groove by capillary force. Thus, even if the reaction gas supplied to the fuel cell flows at a low rate, for example, it is still possible to improve water discharge performance using capillary force.

(3) In the fuel cell of the above aspect, a part of the groove closer to the bottom surface may be smaller in width than a part of the groove closer to the rib part.

In the fuel cell of the above aspect, a width of a portion of the groove that is closer to the rib part among the rib part and the bottom surface is wider than a width of a portion of the groove that is closer to the bottom surface among the rib part and the bottom surface. This allows generated water accumulated between the rib part and the gas diffusion layer to be guided to the part of the groove having the comparatively large width. Thus, even if the separator is composed of a material having a comparatively low hydrophilic property and resultant capillary force is comparatively small, it is still possible to improve water discharge performance.

(4) In the fuel cell of the above aspect, the groove may have a constant width.

In the fuel cell of the above aspect, the groove has a constant width. This allows the groove to be provided easily, compared to a configuration where a groove has a width differing between sites.

(5) In the fuel cell of the above aspect, the groove may tilt in a direction in which the reaction gas flows.

In the fuel cell of the above aspect, the groove tilts in the direction in which the reaction gas flows. This allows generated water in the groove to be easily discharged by the flow of the reaction gas to the outside of the fuel cell. Thus, it is possible to improve water discharge performance of the fuel cell.

What is claimed is:

1. A fuel cell comprising a membrane electrode assembly, gas diffusion layers in a pair provided in such a manner that the membrane electrode assembly is interposed therebetween, and separators in a pair provided in such a manner that the gas diffusion layers in a pair are interposed therebetween, wherein
at least one of the separators in a pair comprises on a surface facing the gas diffusion layer: a flow path part causing a reaction gas to flow therein; and a rib part provided next to the flow path part and in contact with the gas diffusion layer, wherein
flow path part comprises: a bottom surface spaced apart from the gas diffusion layer; and a side portion connecting the bottom surface and the rib part to each other, wherein
the side portion is provided with a groove extending from a connection between the side portion and the rib part toward the bottom surface.

2. The fuel cell according to claim 1, wherein
a width of a portion of the groove that is closer to the rib part among the rib part and the bottom surface is narrower than a width of a portion of the groove that is closer to the bottom surface among the rib part and the bottom surface.

3. The fuel cell according to claim 1, wherein
a width of a portion of the groove that is closer to the rib part among the rib part and the bottom surface is wider than a width of a portion of the groove that is closer to the bottom surface among the rib part and the bottom surface.

4. The fuel cell according to claim 1, wherein
the groove has a constant width.

5. The fuel cell according to claim 1, wherein
the groove tilts in a direction in which the reaction gas flows.
